(19) United States
(12) Patent Application Publication
(10) Pub. No.: US 2025/0308807 A1
(43) Pub. Date: Oct. 2, 2025

(54) ELECTROLYTIC CAPACITOR

(71) Applicant: Panasonic Intellectual Property Management Co., Ltd., Osaka (JP)

(72) Inventors: Takahiro Kawaguchi, OSAKA FU (JP); Norihiko Ogata, OSAKA FU (JP)

(73) Assignee: Panasonic Intellectual Property Management Co., Ltd., Osaka (JP)

(21) Appl. No.: 19/093,511

(22) Filed: Mar. 28, 2025

(30) Foreign Application Priority Data
Mar. 29, 2024 (JP) 2024-056410

(51) Int. Cl. H01G 9/052; H01G 9/15

(52) U.S. Cl. CPC H01G 9/052; H01G 9/15

(57) ABSTRACT

An electrolytic capacitor includes a capacitor element including: a porous anode body having a dielectric layer; an anode wire; and a conductive polymer. In a Log differential pore size distribution, based on volume, of voids in the anode body having the dielectric layer, a first peak for a first pore diameter D1 and a second peak for a second pore diameter D2 (D1<D2) are observed. D2/D1 is 2.7 or more. A ratio (Rpm) of the area of the conductive polymer in an intermediate region to the area of the intermediate region is 10% or more. The distribution is measured for an element cross section of the capacitor element that intersects the anode wire. The intermediate region includes, in the element cross section, a midpoint between a center of the anode wire and a point on an outer surface of the capacitor element, located farthest from the center.

### CROSS REFERENCE TO RELATED APPLICATION

The present application is based on and claims priority under 35 U.S.C. § 119 with respect to the Japanese Patent Application No. 2024-056410, filed on Mar. 29, 2024, of which entire content is incorporated herein by reference into the present application.

### TECHNICAL FIELD

The present disclosure relates to an electrolytic capacitor.

### BACKGROUND

Japanese Laid-Open Patent Publication No. 2008-244184 proposes “a solid electrolytic capacitor including an anode body constituted by a sintered body of metal particles, a dielectric layer provided on the surface of the anode body, and a conductive polymer layer provided on the surface of the dielectric layer, wherein the anode body has a first anode portion and a second anode portion provided to cover the first anode portion, and the particle diameter of the metal particles of the second anode portion is smaller than the particle diameter of the metal particles of the first anode portion.”

### SUMMARY

Development of high-performance electrolytic capacitor in which each of the equivalent series resistance (ESR), the leakage current (LC), and the capacity degradation rate is reduced is promoted. However, there is still room for improvement.

One aspect of the present disclosure relates to an electrolytic capacitor that includes a capacitor element including: an anode body that is porous; an anode wire partially embedded in the anode body; a dielectric layer formed on a surface of the anode body; and a conductive polymer covering at least a part of the dielectric layer, wherein in a Log differential pore size distribution, based on volume, of voids in the anode body having the dielectric layer, measured for an element cross section of the capacitor element that intersects the anode wire, a first peak with its maximum at a first pore diameter D1 and a second peak with its maximum at a second pore diameter D2 are observed, and a ratio (D2/D1) of the second pore diameter D2 to the first pore diameter D1 is 2.7 or more, the Log differential pore size distribution is measured in an intermediate region of the element cross section, the intermediate region includes, in the element cross section, a midpoint between a center of the anode wire and a point on an outer surface of the capacitor element, located farthest from the center, and a ratio (Rpm) of an area of the conductive polymer in the intermediate region to an area of the intermediate region is 10% or more.

According to the present disclosure, a high-performance electrolytic capacitor can be provided.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a diagram illustrating the positions of element cross sections.

FIG. 2 is a diagram illustrating an example of an intermediate region of an element cross section.

FIG. 3 is a schematic cross-sectional view of an example of an electrolytic capacitor according to an embodiment of the present disclosure.

FIG. 4 is a view of image data of the intermediate region in an Example.

FIG. 5 is a graph representation showing a Log differential pore size distribution, based on volume, of voids in an anode body having a dielectric layer, determined from an element cross section of a capacitor element in an Example.

### DETAILED DESCRIPTION

Hereinafter, an embodiment of the present disclosure will be described by way of example. However, the present disclosure is not limited to the examples described below. In the following description, specific numerical values and materials may be exemplified in some cases, but other numerical values and other materials may be adopted as long as the effects of the present disclosure can be obtained. Elements of continuation of well-known electrolytic capacitors may be applied to elements of configuration other than the characteristic parts of the present disclosure. In the present description, the phrase “a numerical value A to a numerical value B” means to include the numerical value A and the numerical value B.

### [Electrolytic Capacitor]

An electrolytic capacitor (hereinafter, also referred to as “capacitor (C)”) according to an embodiment of the present disclosure includes an anode body that is porous, an anode wire partially embedded in the anode body, a dielectric layer formed on the surface of the anode body, and a conductive polymer covering at least a part of the dielectric layer. The smallest unit of an electrolytic capacitor including an anode body, an anode wire, a dielectric layer, and a conductive polymer is also referred to as “capacitor element”. The capacitor (C) is a concept encompassing both the electrolytic capacitor and the capacitor element.

The capacitor element is divided into an anode portion and a cathode portion. The anode portion and the cathode portion are insulated by a dielectric layer. The anode body and the anode wire constitute the anode portion. The cathode portion includes at least a solid electrolyte layer, and may include a cathode leading layer.

The solid electrolyte layer contains at least a conductive polymer. An electrolytic capacitor including a solid electrolyte layer (or a conductive polymer) is also referred to as a “solid electrolytic capacitor”.

The cathode leading layer may include a carbon layer formed on the solid electrolyte layer, and a metal paste layer formed on the carbon layer, for example. The carbon layer may be formed of a resin and a conductive carbon material such as graphite. The metal paste layer may be formed of a resin and metal particles (e.g., silver particles), or may be formed of a known silver paste, for example.

The anode wire is made of metal. A part of the anode wire is embedded in the anode body and the rest thereof protrudes from the anode body. That is, the anode wire has an embedded part embedded in the anode body and a protruding part protruding outward of the anode body.

The dielectric layer is formed on at least a part of the surface of the anode body. The dielectric layer is formed, for example, by performing chemical conversion treatment on the anode body to grow an oxide film at the surface of the anode body. In chemical conversion treatment, the anode body may be immersed in a chemical conversion solution to anodize the surface of the anode body. The oxide film may be formed using a gas phase method such as atomic layer deposition (ALD). The anode body may be heated in an atmosphere containing oxygen to oxidize the surface of the anode body.

Due to its porosity, the anode body having the dielectric layer has voids. The pore size distribution or pore volume distribution of the voids in an anode body greatly affects the performance of an electrolytic capacitor.

In the present disclosure, the Log differential pore size distribution, based on volume, of the voids in the anode body having the dielectric layer is controlled. However, the Log differential pore size distribution, based on volume, of the voids in the anode body having the dielectric layer is a local distribution within the anode body, measured in an element cross section that intersects the anode wire of the capacitor element. The element cross section may be a cross section that intersects the anode wire and that is parallel to the end face of the anode body from which a part of the anode wire protrudes. Alternatively, the element cross section may be a cross section perpendicular to the anode wire.

The Log differential pore size distribution, based on volume, of the void measured in the element cross section of the capacitor element is measured in an intermediate region of the element cross section. The intermediate region is defined so as to include, in the element cross section, a midpoint (hereinafter also referred to as “midpoint (M)”) between the center (hereinafter also referred to as “center (C)”) of the anode wire and a point (hereinafter also referred to as “point (O)”) on the outer surface of the capacitor element, located farthest from the center (C). Hereinafter, the Log differential pore size distribution, based on volume, of voids measured in the local intermediate region within the anode member is also referred to as “Log differential pore size distribution (D)”.

When the element cross section is rectangular, the point (O) is located at the tip of a corner of the rectangle. The center (C) of the anode wire may be specified as the centroid in an aera of a cross section of the anode wire. The midpoint (M) is located on a line segment connecting the center (C) and the point (O). The distance between the midpoint (M) and the center (C) is equal to the distance between the midpoint (M) and the point (O). The intermediate region includes the midpoint (M) and may be a region having an area of 2500 μm² to 7500 μm², for example. The intermediate region may be a region including the midpoint (M) as its centroid of its area.

In the Log differential pore size distribution (D), a first peak, with its maximum at a first pore diameter D1, is observed, and a second peak, with its maximum at a second pore diameter D2 that is larger than the first pore diameter D1, is observed. Hereinafter, a region in which pores constituting the first peak are present is also referred to as first region (R1), and a region in which pores constituting the second peak are present is also referred to as second region (R2).

As the metal forming the anode body, a valving metal such as aluminum (Al), titanium (Ti), tantalum (Ta), niobium (Nb), zirconium (Zr), or hafnium (Hf) is used. One of these may be used alone, or two or more of these may be used in combination. Among these, it is desirable to use at least one of Ta and Nb.

The porous anode body may be a sintered body of a shaped body of metal particles. In this case, the anode body is formed by shaping material particles and sintering the resulting product. Examples of the material particles include metal particles, alloy particles, and metal compound particles. One kind of these particles may be used alone or two or more kinds thereof may be used in combination.

The first region (R1) may be a region in which first particles being the material particles are sintered to each other, and the second region (R2) may be a region in which second particles (R2) being the material particles are sintered to each other.” The Log differential pore size distribution (D) having a first peak with its maximum at the first pore diameter D1 and a second peak with its maximum at the second pore diameter D2 may be achieved by making an average particle diameter d1 of the first particles smaller than an average particle diameter d2 of the second particles.

The average particle diameter d1 of the first particles being the material particles may be, for example, 1 μm or less, or may be 0.3 μm or less. The average particle diameter d2 of the second particles being the material particles may be, for example, 3 μm or more, or may be 5 μm or more. Use of the first particles and the second particles such as above makes it easy to achieve a Log differential pore size distribution (D) having a sharp first peak and a distinct second peak.

The average particle diameter d1 of the first particles and the average particle diameter 2d of the second particles are median diameters in a volume-based particle size distribution determined using a laser diffraction and scattering particle size distribution analyzer.

The first region is necessary to provide a specific surface area large enough for the anode body, and an increase in the specific surface area contributes to an increase in electrostatic capacity. On the other hand, the second region has a low bulk resistance and is easily penetrated by the conductive polymer for electricity leading. Therefore, wide conductive paths are formed in the second region.

Here, a ratio (D2/D1) of the second pore diameter D2 to the first pore diameter D1 is controlled to be 2.7 or more. By setting the ratio D2/D1 to 2.7 or more, the packing rate of the conductive polymer in the voids can be increased. The pores constituting the second peak play an important role as movement paths for the conducive polymer to be packed in the voids. When the ratio D2/D1 in the Log differential pore size distribution (D) in the intermediate region is a larger value of 2.7 or more, penetration of the conductive polymer from the pores constituting the second peak to the pores constituting the first peak is increased. Therefore, the packing rate of the conductive polymer within the anode body having the dielectric layer tends to be high.

The ratio D2/D1 should be 2.7 or more, and may be 2.8 or more, 2.9 or more, or 3.0 or more. When the ratio D2/D1 is controlled to be a value such as above, penetration of the conductive polymer from the pores constituting the second peak to the pores constituting the first peak is increased. The upper limit of the ratio D2/D1 is, for example, 4.0 or less, and may be 3.5 or less, or 3.4 or less. The intermediate region having such a Log differential pore size distribution (D) has voids that are further suitable for conductive polymer packing.

Note that the Log differential pore size distribution (D) in the “intermediate region” is a Log differential pore size distribution at a local site within the capacitor element, and therefore cannot be measured by a conventional general method of determining a pore size distribution, such as mercury intrusion (a measurement method using a mercury porosimeter).

A proportion (Rpm) of the area of the conductive polymer (solid electrolyte layer) in the intermediate region to the area of the intermediate region is controlled to be 10% or more. That is, in the capacitor (C) according to present disclosure, the packing rate of the conductive polymer to the voids in the intermediate region is high, and a large area of the dielectric layer is covered with the thick conductive polymer. Therefore, within the anode body having the dielectric layer: peeling of the conductive polymer from the dielectric layer is reduced; heat generation is suppressed because the conductive paths are large enough to reduce resistance; and a decrease in effective area can be restricted even after oxidative degradation. Thus, a high-performance electrolytic capacitor in which each of the ESR, the leakage current, and the capacity degradation rate is reduced can be obtained.

The proportion (Rpm) is preferably 10.5% or more, and more preferably 11% or more. The proportion (Rpm) can be controlled according to the ratio D2/D1. The proportion (Rpm) can be further effectively controlled by appropriately selecting at least one of the parameters described below, in addition to control of the ratio D2/D1.

A difference (D2-D1) between the first pore diameter D1 and the second pore diameter D2 may be 1.2 μm or more, 1.5 μm or more, or 2.0 μm or more. In this case, penetration of the conductive polymer in the intermediate region from the pores constituting the second peak to the pores constituting the first peak is further increased to form further wide conductive paths.

The difference (D2-D1) of 1.2 μm or more means that a plurality of conductive paths having different functions can be formed in the intermediate region deep within the anode body. The larger the second pore diameter D2, the wider the conductive paths formed by the conductive polymer in the second region, which is advantageous in reducing the ESR. By contrast, the smaller the first pore diameter D1, the larger the specific surface area of the first region, which increases the electrostatic capacity. Fine conductive paths formed by the conductive polymer in first region function as tributaries that lead to the wide conductive paths in the second region. As a result, conductive paths with excellent current collector performance as a whole are formed.

The second pore diameter D2 is, for example, 2.0 μm or more, and may be 2.5 μm or more. As a result of the second pore diameter D2 being 2.0 μm or more, the bulk resistance of the second region becomes lower, and wider conductive paths can be formed in the capacitor (C). That is, as a result of sufficiently increasing the second pore diameter D2, it is advantageous to reduce the ESR.

The second pore diameter D2 is 5 μm or less, and may be 3 μm or less. As a result of the second pore diameter D2 being 5 μm or less, the specific surface area of the second region is also increased to further increase the electrostatic capacity.

The first pore diameter D1 is, for example, 0.7 μm or more, and may be 0.8 μm or more. As a result of the first pore diameter D1 being 0.7 μm or more, penetration of the conductive polymer into the pores in the first region is further increased to form wider conductive paths.

The first pore diameter D1 is 2.0 μm or less, and may be 1.5 μm or less. As a result of the first pore diameter D1 being 2.0 μm or less, the specific surface area of the first region is remarkably increased to further increase the electrostatic capacity.

In order to obtain a high-performance electrolytic capacitor in which each of the ESR, the leakage current, and the capacity degradation rate is reduced, it is desired to form pores having a sufficiently large volume in the intermediate region of the anode body having the dielectric layer and form the first region and the second region in a well-balanced manner. In view of balancing between the first region and the second region, a ratio (V1/V2) of a volume V1 of the pores constituting the first peak to a volume V2 of the pores constituting the second peak is, for example, 0.4 or more and 0.62 or less, and preferably 0.5 to 0.6.

A proportion (Rvd) of the area of a remaining area of the intermediate region to the area of the intermediate region is, for example, 30% or more, and may be 31% or more, or 33% or more. Here, the remaining area is the area of a part of the intermediate region, excluding the area of the anode body having the dielectric layer within the intermediate region. The proportion (Rvd) corresponds to the “porosity” of the intermediate region of the anode body having the dielectric layer. The proportion (Rvd) (porosity) may be 40% or less, for example. In the above configuration, even a deep part of the anode body can be easily filled up with much conductive polymer.

### (Log Differential Pore Size Distribution (D) Determination)

Hereinafter, an example of a method of determining a Log differential pore size distribution (D) will be described with reference to the accompanying drawings. First, an element cross section that intersects the anode wire of the capacitor element is formed in the capacitor (C).

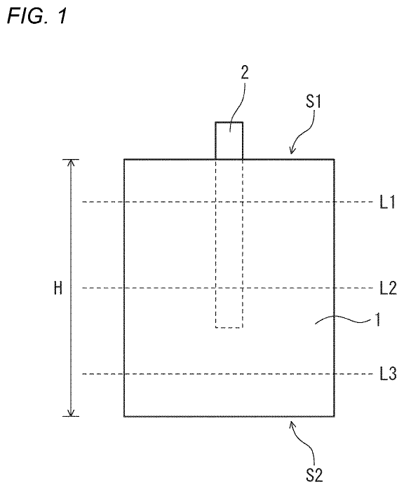

FIG. 1 illustrates examples of the positions that form element cross sections. An anode body 1 is divided into four parts by three element cross sections L1, L2, and L3 that intersect the anode wire 2. Each of the element cross sections L1, L2, and L3 is parallel to an end face S1 of the anode body 1, from which a part of the anode wire 2 protrudes. Given that H represents the distance from the end face S1 of the anode body to a back surface S2 opposite to the end face S1, the position of L1 is a position apart from the end face S1 by 0.12H. The position of L2 is a position apart from the end face S1 by 0.5H. The position of L3 is a position apart from the end face S1 by 0.88H.

The element cross sections are treated with polishing and/or using a cross sectional polisher (CP). Thereafter, an intermediate region having an area of 2500 μm² to 7500 μm² is defined.

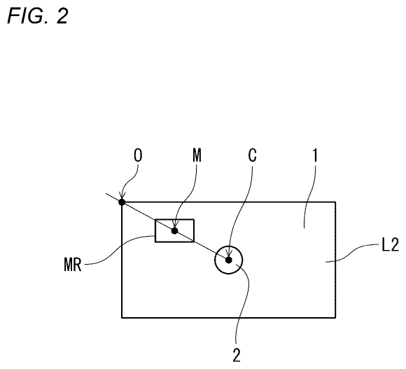

FIG. 2 is a diagram illustrating an example of an intermediate region MR defined in the element cross section L2. The intermediate region MR is defined to include a midpoint (M) between the center (C) of the anode wire 2 and a point (O) on the outer surface of the capacitor element, located farthest from the center (C) in the element cross section L2. The midpoint (M) is located on a line segment connecting the center (C) and the point (O). The distance between the midpoint (M) and the center (C) is equal to the distance between the midpoint (M) and the point (O). Since the element cross section L2 is rectangular, the point (O) is located at the tip of a corner of the rectangle. The center (C) of the anode wire is the centroid in an area of a cross section of the anode wire 2. The midpoint (M) is the centroid of an area of the intermediate region (MR). The intermediate region (MR) is rectangular in the illustrated example, but the shape of the intermediate region (MR) is not limited.

Next, a reflected electron image and a secondary electron image of the defined intermediate region are captured using a scanning electron microscopy (SEM). When the captured reflected electron image and secondary electron image are quantized by discriminant analysis for combination, the metal portion of the anode body, the dielectric layer, the conductive polymer, the voids, and the like can be identified, and each distribution state of the metal portion, the dielectric layer, the conductive polymer, and the voids can be determined.

For example, when an image of the intermediate region is divided into a first image portion of the anode body having the dielectric layer and a second image portion other than the first portion, the second image portion indicates the distribution state of voids in the anode body having the dielectric layer. That is, analysis of the second image portion can obtain a Log differential pore size distribution, based on volume, (Log differential pore size distribution (D)) of the voids in the anode body having the dielectric layer. Further, the second image portion can be divided into a packed portion packed with the conductive polymer and a non-packed portion not packed with the conductive polymer.

The second image portion is acquired as a collection of a plurality of (at least 1000) voids. The plurality of voids forming the collection have different shapes, but all of the voids are converted into circles. Specifically, each void is regarded as a circle (equivalent circle) having the same area as the area of the void. Then, the diameter (equivalent circle diameter) of the equivalent circle is obtained. Given that S (μm²) represents the area of a certain void, the equivalent circle diameter of the void is calculated as 2√S√π. Then, the void is regarded as a column having a thickness of 1 μm, and a cumulative pore volume distribution is obtained. The cumulative pore volume distribution is approximated to the sum of two cumulative distribution functions. The resultant approximation expression is differentiated with respect to a small range of pore diameters on the logarithmic scale to calculate a Log differential pore size distribution (D).

A Log differential pore size distribution (D) may be calculated using image-analysis particle diameter distribution measuring software (e.g., MAC-View (Mountech Co., Ltd.)). A Log differential pore size distribution (D) is calculated for each intermediate region of the three element cross sections L1, L2 and L3, and the average of all the calculated Log differential pore size distributions (D) is determined.

Approximation of the Log differential pore size distribution (D) to the sum of the two normal distributions can separate the first peak with its maximum at the first pore diameter D1 and the second peak with its maximum at the second pore diameter D2. The volume of the pores constituting the first peak is represented by V1, and the volume of the pores constituting the second peak is represented by V2. V1 and V2 are calculated by converting the Log differential pore size distribution (D) in which the first peak and the second peak are separated to a pore volume distribution.

When the Log differential pore size distribution (D) is approximated to the sum of a normal distribution AD1 corresponding to the first peak and a normal distribution AD2 corresponding to the second peak, the approximation expression is B((1−P2) AD1+P2·AD2). Here, B represents a constant, and P2 represents a ratio of the volume V2 of the pores constituting the second peak to the total pore volume (V1+V2) in the pore volume distribution.

### (Determination of Ratio (Rpm) of Area of Conductive Polymer)

As described previously, image analysis of the quantized electron image of the intermediate region can identify the metal portion of the anode body, the dielectric layer, the conductive polymer, and the void, for example. Therefore, the proportion of the area of the image portion of the conductive polymer to the area of the intermediate region can be determined as a ratio (Rpm).

The conductive polymer may be a π-conjugated polymer. Examples of the conductive polymer include polypyrrole, polythiophene, polyaniline, and derivatives of these. One of these may be used alone or some of these may be used in combination. The conductive polymer may be a copolymer of two or more types of monomers. The term “derivative of a conductive polymer” means a polymer having a conductive polymer as a basic skeleton. For example, examples of derivatives of polythiophene include poly(3,4-ethylenedioxythiophene).

Preferably, a dopant is added to the conductive polymer. The dopant can be selected according to the conductive polymer, and a known dopant may be used. Examples of the dopant include low molecular weight dopants such as benzenesulfonic acid, alkylbenzene sulfonic acids such as p-toluenesulfonic acid, naphthalenesulfonic acid and anthraquinonesulfonic acid, and polymer dopants such as polystyrenesulfonic acid, polyester sulfonic acid, and phenolic sulfonic acid novolac resin.

One example of the solid electrolyte layer is formed with poly(3,4-ethylenedioxythiophene) (PEDOT) doped with polystyrenesulfonic acid (PSS).

The solid electrolyte layer containing the conductive polymer is formed on at least a part of the dielectric layer by impregnating the dielectric layer with a monomer or an oligomer, followed by polymerization of the monomer or the oligomer by chemical polymerization or electrolytic polymerization, or by impregnating the anode body with the dielectric layer formed thereon with a solution or a liquid dispersion of the conductive polymer (and a dopant as necessary), followed by drying.

### (Determination of Rate of Remaining Area (Rvd (Porosity)))

As described previously, image analysis of the quantized electron image of the intermediate region can identify the metal portion of the anode body, the dielectric layer, the conductive polymer, and the void, for example. Therefore, the rate (Rvd) (porosity) of the remaining area of the intermediate region to the area of the intermediate region can be measured. Here, the remaining area is the area of a part of the intermediate region, excluding the area of the image portion of the anode body having the dielectric layer within the intermediate region. The rate (Rvd) can be said to be a proportion of the area of the second image portion to the area of the intermediate region when the image of the intermediate region is divided into the first image portion of the anode body having the dielectric layer and the second image portion other than the first image portion.

### [Electrolytic Capacitor Production Method]

One example of an electrolytic capacitor production method will be described. First, an anode body is prepared. The anode body may be a sintered body of a shaped body of a secondary particle mixture. The secondary particle mixture is a mixture of first secondary particles in which first particles are agglomerated, and second secondary particles in which second particles are agglomerated. The first secondary particles are obtained by heating the first particles for agglomeration. The second secondary particles are obtained by heating the second particles for agglomeration. That is, previously agglomerated first particles and previously agglomerated second particles are used for mixing the first and second particles.

It is possible that the first peak with its maximum at the first pore diameter D1 and the second peak with its maximum at the second pore diameter D2 are observed in the Log differential pore size distribution (D) of the anode body having the dielectric layer through shaping the secondary particle mixture in which the previously agglomerated first particles and the previously agglomerated second particles are mixed, and sintering the resultant shaped body.

In formation of the secondary particle mixture, the ratio (D2/D1) of the second pore diameter D2 to the first pore diameter D1 may be controlled to be 2.7 or more by controlling the average particle diameter d1 of the first particles being the material particles, the average particle diameter d2 of the second particles being the material particles, the size of the first secondary particles, and the size of the second secondary particles, for example.

In the step of obtaining the secondary particle mixture, the proportion of the second secondary particles to the total of the first secondary particles and the second secondary particles may be, for example, 5% by mass or more and 40% by mass or less, or may be 5% by mass or more and 20% by mass or less, or 10% by mass or more and 20% by mass or less. When the proportion of the second secondary particles is 40% by mass or less, the second secondary particles are surrounded by the first secondary particles, which facilitates thermal shrinkage. As a result, sintering between the first secondary particles and the second secondary particles and sintering between the second secondary particles tend to progress sufficiently.

Next, the secondary particle mixture is shaped into a predetermined shape to obtain a shaped body. The shape of the shaped body is selected according to the shape of the anode body. The shape of the anode body is not particularly limited, and has paired opposite main surfaces and corresponding side surfaces that intersect the paired main surfaces, for example. For example, a part of an anode wire is embedded in the secondary particle mixture, and the secondary particle mixture is press shaped into a cuboid shape. Thereafter, the obtained shaped body is sintered to form an anode body in which a part of the anode wire is embedded.

In the manner as described above, sintering the shaped body can obtain an anode body having the first region in which the first particles are sintered to each other and the second region in which the second particles are sintered to each other.

Next, chemical conversion or the like is performed on the anode body to form a dielectric layer on the surface of the anode body. Thereafter, a cathode portion covering at least a part of the dielectric layer is formed.

Hereinafter, the present disclosure will be described more specifically with reference to the drawings. However, the following examples are not intended to limit the present invention. The drawings indicated below are schematic and do not accurately reflect the shape, dimension, number, and the like of the actual members.

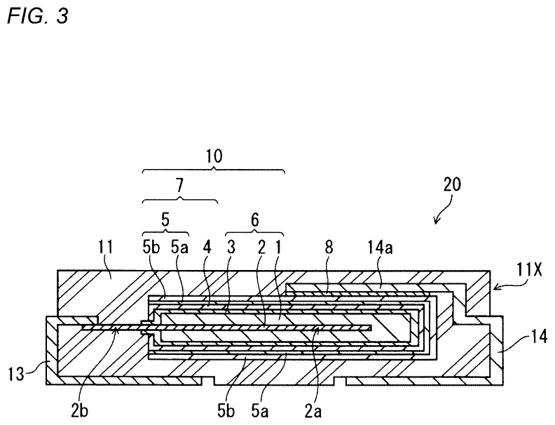

FIG. 3 is a schematic cross sectional view of an example of an electrolytic capacitor according to an embodiment of the present disclosure. An electrolytic capacitor 20 includes a capacitor element 10 having an anode portion 6 and a cathode portion 7, an exterior resin 11 that seals the capacitor element 10, a first terminal (anode lead terminal) 13 that is electrically connected to the anode portion 6 and that is partially exposed on the outer face 11X of the exterior resin 11, and a second terminal (cathode lead terminal) 14 that is electrically connected to the cathode portion 7 and that is partially exposed on the outer face 11X of the exterior resin 11. The anode portion 6 includes an anode body 1 and an anode wire 2. A part (embedded part 2a) of the anode wire 2 is embedded to the anode body 1 and the rest (protrusion 2b) thereof is protruded from the anode body 1. The first terminal 13 is bonded to the anode wire 2 (more practically, the protrusion 2b). A connection surface 14a of the second terminal 14 located within the exterior resin 11 is bonded to a cathode leading layer 5 via a conductive member 8.

A dielectric layer 3 is formed on the surface of the anode body 1. The cathode portion 7 includes a solid electrolyte layer 4 covering at least a part of the dielectric layer 3, and a cathode leading layer 5 covering the surface of the solid electrolyte layer 4. The solid electrolyte layer 4 contains a conductive polymer. The cathode leading layer 5 includes a carbon layer 5a formed to cover the solid electrolyte layer 4, and a metal paste layer 5b formed on the surface of the carbon layer 5a. The carbon layer 5a contains a resin and a conductive carbon material such as graphite. The metal paste layer 5b contains metal (e.g., silver) particles and a resin, for example. Note that the configuration of the cathode leading layer 5 is not limited to the above configuration. The configuration of the cathode leading layer 5 should be any configuration having a current collecting function.

The exterior resin is provided around the capacitor element so that the capacitor element is not exposed on the surface of the electrolytic capacitor. Further, the exterior resin insulates the first terminal and the second terminal. A known exterior resin used for electrolytic capacitors may be applied to the exterior resin. For example, the exterior resin may be formed with an insulative resin material used for capacitor element sealing. The exterior resin may be formed in a manner that a capacitor element is set in a mold, and an uncured thermosetting resin and a filler are introduced into the mold and cured, for example, by transfer molding or compression molding.

The first terminal corresponds to an anode terminal electrically connected to the anode portion (specifically, the anode wire) of the capacitor element. The second terminal corresponds to a cathode terminal electrically connected to the cathode portion of the capacitor element.

### (Supplementary Remarks)

The following techniques are disclosed by the above description.

### (Technique 1)

An electrolytic capacitor including a capacitor element including:
an anode body that is porous;
an anode wire partially embedded in the anode body;
a dielectric layer formed on a surface of the anode body; and a conductive polymer covering at least a part of the dielectric layer, wherein in a Log differential pore size distribution, based on volume, of voids in the anode body having the dielectric layer, measured for an element cross section of the capacitor element that intersects the anode wire,
   a first peak with its maximum at a first pore diameter D1 and a second peak with its maximum at a second pore diameter D2 are observed, and
   a ratio (D2/D1) of the second pore diameter D2 to the first pore diameter D1 is 2.7 or more,
the Log differential pore size distribution is measured in an intermediate region of the element cross section,
the intermediate region includes, in the element cross section, a midpoint between a center of the anode wire and a point on an outer surface of the capacitor element, located farthest from the center, and
a ratio (Rpm) of an area of the conductive polymer in the intermediate region to an area of the intermediate region is 10% or more.

### (Technique 2)

The electrolytic capacitor according to Technique 1, wherein
a difference (D2-D1) between the first pore diameter D1 and the second pore diameter D2 is 1.2 μm or more.

### (Technique 3)

The Electrolytic capacitor according to Technique 1 or 2, wherein
the second pore diameter D2 is 2.0 μm or more, and
the first pore diameter D1 is 0.7 μm or more.

### (Technique 4)

The electrolytic capacitor according to Technique 3, wherein
the second pore diameter D2 is 5 μm or less, and
the first pore diameter D1 is 2 μm or less.

### (Technique 5)

The electrolytic capacitor according to any one of Techniques 1 to 4, wherein
a ratio (V1/V2) of a volume V1 of pores constituting the second peak to a volume V2 of pores constituting the first peak is 0.4 or more and 0.62 or less.

### (Technique 6)

The electrolytic capacitor according to any one of Techniques 1 to 5, wherein
a rate (Rvd) of a remaining area to an area of the intermediate region is 30% or more, the remaining area being an area of a part of the intermediate region, excluding an area of the anode body having the dielectric layer within the intermediate region.

Hereinafter, experiment examples and examples of the present invention will be described.

However, the present invention is not limited to the following.

### Examples 1 and 2 and Comparative Example 1

In the manner described below, 1000 electrolytic capacitors were prepared for each Examples. Each of electrolytic capacitors (rated voltage 35 V, electrostatic capacity 47 μF) is as illustrated in FIG. 1.

### (i) Capacitor Element Production

(i-i) Anode Body Production

With respect to each of the electrolytic capacitors, Ta was used as the material of an anode body. A Ta wire was used as an anode wire. One end of the Ta wire was embedded in a secondary particle mixture, and the secondary particle mixture was shaped into a cuboid shape, after which the resulting shaped body was sintered in vacuo. As a result, an anode body (i.e., an anode portion) made of a porous sintered body of Ta, with a part of the Ta wire embedded therein, was obtained.

Appropriate selection was made, for example, for the sizes of the first secondary particles and the second secondary particles constituting the secondary particle mixture, the mass ratio between the first secondary particles and the second secondary particles in the secondary particle mixture, the average particle diameter of the first particles constituting the first secondary particles, and the average particle diameter of the second particles constituting the second secondary particles so as to obtain particle differential pore size distributions (D) each having the physical property values (D1, D2, the ratio D2/D1, the difference (D2−D1), V1, V2, and the ratio V1/V2) shown in Table 1, in the intermediate region of a corresponding one of the capacitors. The physical property values in Tables 1 for each capacitor were obtained by capturing a reflected electron image and a secondary electron image of a rectangular intermediate region having an area of 5000 μm² using a SEM at 1500 times magnification. In Table 1, the values for V1 and V2 each are a relative value when the value of V1 in an electrolytic capacitor B1 of Comparative Example 1 is taken as 1.00.

TABLE 1

| | | | | | V1 | V2 | | | | | | | |
|---|---|---|---|---|---|---|---|---|---|---|---|---|---|
| | D1 | D2 | | D2 − D1 | Relative | Relative | | Rpm | Rvd | Rt | ESR | LC | ΔCap |
| | μm | μm | D2 − D1 | μm | value | value | V1/V2 | % | % | % | mΩ | μA | % |
| A1 | 0.87 | 2.6 | 3.04 | 1.77 | 1.12 | 1.91 | 0.59 | 12.0 | 35.2 | 64.8 | 49.7 | 0.77 | −11 |
| A2 | 0.73 | 2.1 | 2.82 | 1.33 | 1.09 | 1.74 | 0.62 | 10.8 | 31.9 | 68.1 | 51.1 | 0.84 | −26 |
| B1 | 0.60 | 1.5 | 2.44 | 0.86 | 1.00 | 1.60 | 0.63 | 9.9 | 29.0 | 71.0 | 55.9 | 1.24 | −52 |

(i-ii) Dielectric Layer Formation

A uniform oxide film was formed as a dielectric layer on the surface of the anode body and the surface of a part of a wire by immersing the anode body and the part of the wire in a chemical conversion tank filled with an aqueous phosphoric acid solution being an aqueous electrolyte solution for anodization. The anodization was performed in the aqueous phosphoric acid solution containing phosphoric acid in a concentration of 0.1% by mass at an electrolytic voltage of 10 V.

(i-iii) Solid Electrolyte Layer Formation

Next, 3,4-ethylenedioxythiophene (monomer), ferric p-toluenesulfonate (Fe(III)), and 1-butanol were mixed to prepare a polymerization liquid. The anode body having the dielectric layer was immersed in the polymerization liquid, pulled out of the polymerization liquid, and subjected to thermal treatment in the atmosphere. In this case, the ferric p-toluenesulfonate (Fe(III)) functioned as an oxidizer and a dopant. In the manner described above, the monomers were polymerized on the dielectric layer to produce a first conductive polymer containing poly(3,4-ethylenedioxythiophene) (PEDOT) by chemical polymerization.

Subsequently, the anode body with the conductive polymer formed thereon was washed, and then the anode body with the conductive polymer attached thereto was immersed in an aqueous liquid dispersion containing PEDOT as a conjugated polymer and polystyrene sulfonic acid (PSS) as a polymer dopant. After the immersion, the anode body was taken out and subjected to drying treatment under the atmospheric pressure. In the manner described above, a conductive polymer containing PEDOT and PSS was formed so as to cover the first conductive polymer. Thus, an anode having a solid electrolyte layer containing the first and second conductive polymers was obtained.

(i-iv) Carbon Layer Formation

A carbon layer (thickness about 3 μm) was formed on the surface of the solid electrolyte layer by applying a liquid dispersion (carbon paste) of carbon particles to the solid electrolyte layer, followed by heating at 200° C.

(i-v) Metal Paste Layer Formation

A metal paste containing silver particles, a binder resin, and a solvent was applied to the surface of the carbon layer. Thereafter, heating at 200° C. was performed to form a metal paste layer (thickness: 10 μm), thereby obtaining the capacitor element.

### (ii) Electrolytic Capacitor Production

A conductive adhesive material to be a conductive member was applied to the metal paste layer, and a cathode lead terminal was bonded to the metal paste layer. The anode wire and an anode lead terminal were bonded by resistance welding. Subsequently, the capacitor element with the lead terminals bonded thereto was sealed with an exterior resin by transfer molding to produce electrolytic capacitors A1, A2 of Examples 1 and 2 and electrolytic capacitors B1 of Comparative Example 1.

### [Evaluation]

### (1) Initial ESR and Initial Capacity

With respect to the electrolytic capacitors A1, A2, and B1 prepared above, the initial electrostatic capacities Cap(0) (μF) at a frequency of 120 Hz and the initial ESRs (mΩ) at a frequency of 100 kHz were measured using an LCR meter for 4-terminal measurement in an environment at 20° C., and averaged. The results of the ESR measurement are shown in Table 1.

### (2) Leakage Current (LC)

With respect to the electrolytic capacitors A1, A2, and B1 prepared above, a resistor of 1kΩ was connected in series, and leakage currents were measured after the rated voltage was applied using a DC power supply for 1 minute in an environment at 20° C., and averaged. The results are shown in Table 1.

### (3) Capacity Change Rate (ΔCap)

After measurement of Cap(0), ESR, and LC, a high-temperature loading test (accelerated test) was performed. That is, the rated voltage was applied to each of the electrolytic capacitors at a temperature of 145° C. for 250 hours. For each of the electrolytic capacitors after the accelerated test, the electrostatic capacity (Cap(X)) was determined similar to the above case of Cap(0). The electrostatic capacity change rate (ΔCap) was obtained using the following equation. The results are shown in Table 1.

$$Δ Cap ( \% ) = 100 * ( Cap ( 0 ) - Cap ( X ) ) / Cap ( 0 )$$

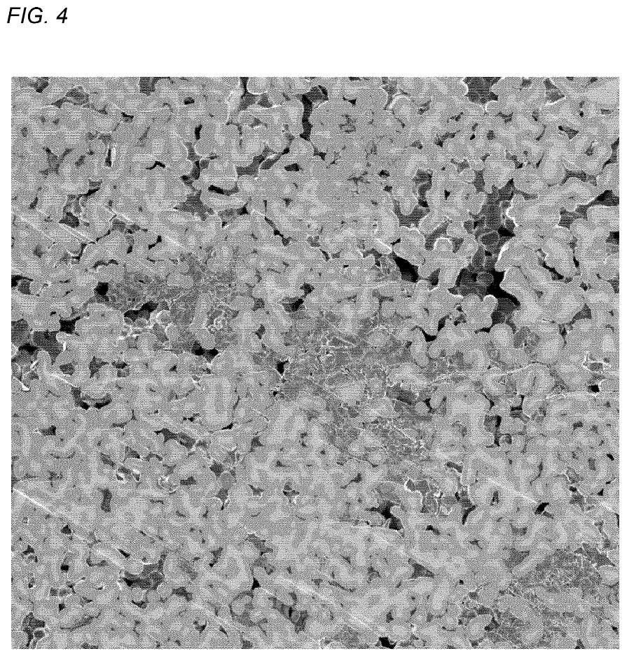

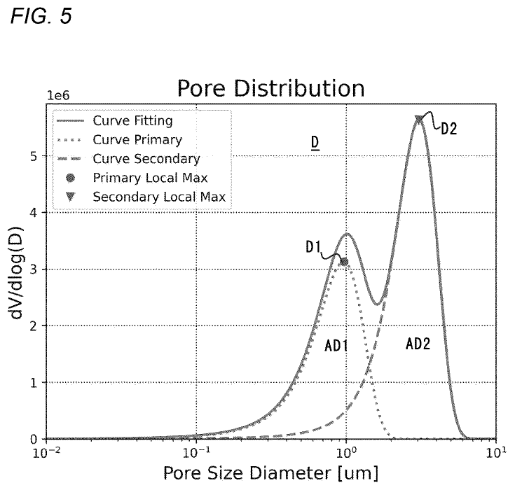

The ratio (Rpm) of the area of the conductive polymer, Rvd (porosity), and the proportion (Rt (%)=100-Rvd) of the area of the anode body having the dielectric layer to the area of the intermediate region were determined by the above-described methods. The results are shown in Table 1. FIG. 4 shows the image data of the intermediate region in the Example. FIG. 5 shows the Log differential pore size distribution, based on volume, of voids in the anode body having the dielectric layer, determined from an element cross section of the capacitor element of the Example. It can be understood that the electrolytic capacitors A1 and A2 each had a ratio D2/D1 of more than 2.7, and a Rpm much higher than that of the electrolytic capacitor B1.

### INDUSTRIAL APPLICABILITY

The present disclosure can be utilized for electrolytic capacitors including a porous anode body.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE NUMERALS

20: Electrolytic capacitor
10: Capacitor element
1: Anode body
2: Anode wire
2a: Embedded part
2b: Protrusion
3: Dielectric layer
4: Solid electrolyte layer
5: Cathode leading layer
5a: Carbon layer
5b: Metal paste layer
6: Anode portion
7: Cathode portion
8: Conductive member
11: Exterior resin
11X: Outer face of Exterior resin
13: First terminal
14: Second terminal
14a: Connection surface

What is claimed is:

1. An electrolytic capacitor comprising a capacitor element including:
an anode body that is porous;
an anode wire partially embedded in the anode body;
a dielectric layer formed on a surface of the anode body; and
a conductive polymer covering at least a part of the dielectric layer, wherein in a Log differential pore size distribution, based on volume, of voids in the anode body having the dielectric layer, measured for an element cross section of the capacitor element that intersects the anode wire,
a first peak with its maximum at a first pore diameter D1 and a second peak with its maximum at a second pore diameter D2 are observed, and
a ratio (D2/D1) of the second pore diameter D2 to the first pore diameter D1 is 2.7 or more,
the Log differential pore size distribution is measured in an intermediate region of the element cross section,
the intermediate region includes, in the element cross section, a midpoint between a center of the anode wire and a point on an outer surface of the capacitor element, located farthest from the center, and
a ratio (Rpm) of an area of the conductive polymer in the intermediate region to an area of the intermediate region is 10% or more.

2. The electrolytic capacitor according to claim 1, wherein
a difference (D2−D1) between the first pore diameter D1 and the second pore diameter D2 is 1.2 μm or more.

3. The electrolytic capacitor according to claim 1, wherein
the second pore diameter D2 is 2.0 μm or more, and
the first pore diameter D1 is 0.7 μm or more.

4. The electrolytic capacitor according to claim 3, wherein
the second pore diameter D2 is 5 μm or less, and
the first pore diameter D1 is 2 μm or less.

5. The electrolytic capacitor according to claim 1, wherein
a ratio (V1/V2) of a volume V1 of pores constituting the second peak to a volume V2 of pores constituting the first peak is 0.4 or more and 0.62 or less.

6. The electrolytic capacitor according to claim 1, wherein
a rate (Rvd) of a remaining area to an area of the intermediate region is 30% or more, the remaining area being an area of a part of the intermediate region, excluding an area of the anode body having the dielectric layer within the intermediate region.
